(19) United States
(12) Patent Application Publication
(10) Pub. No.: US 2025/0369281 A1
(43) Pub. Date: Dec. 4, 2025

(54) TENSION FIXING DEVICE

(71) Applicant: Nien Made Enterprise Co., Ltd., Taichung City (TW)

(72) Inventors: Lin Chen, Taichung City (TW); Hai Bo Liang, Taichung City (TW)

(73) Assignee: Nien Made Enterprise Co., Ltd., Taichung City (TW)

(21) Appl. No.: 19/177,622

(22) Filed: Apr. 13, 2025

(30) Foreign Application Priority Data
May 31, 2024 (TW) 113205794

(51) Int. Cl. E06B 9/42; E06B 9/78

(52) U.S. Cl. CPC E06B 9/42; E06B 9/78

(57) ABSTRACT

A tension fixing device for tensioning an operating member of a window covering, includes a housing, a pushed member, a wheel body disposed on the pushed member, a locking member fixed within the housing between the wheel body and a bottom plate of the pushed member, and a biasing member disposed between the bottom plate and the locking member. When the operating member is tensioned, causing the pushed member to move so that the wheel body is spaced from the locking member by a gap larger than the diameter of the operating member, the operating member can move with respect to the locking member. When the operating member is slack such that the biasing member forces the pushed member to move, causing the gap to be smaller than the diameter of the operating member, the locking member interferes with the operating member to restrict the operating member from moving.

### BACKGROUND OF THE DISCLOSURE

### 1. Field of the Disclosure

The present disclosure generally relates to a fixing device for fixing the operating cord of the window covering, and more particularly to a tension fixing device for adjusting and maintaining the tension in the operating cord loop of the window covering.

### 2. Description of the Prior Art

Window coverings are common home decors serving to regulate interior lighting. One type of operating cord used to control the extension and retraction of the shading materials of window coverings or adjust its light transmittance is an annular-shaped cord loop. One section of the cord loop passes through a control mechanism located on an upper part of the window covering, while another section of the cord loop dangles by one side of the window covering. The user can pull either the front or rear section of the cord loop, depending on desired adjustment, to control the status of the window covering and regulate the interior light.

Operating the window covering with a cord loop offers advantages such as ease of use and a neat appearance but also presents certain safety concerns. One issue is that the dangling cord loop may sway due to wind and become entangled with nearby objects, potentially causing them to fall and break. Another concern is the risk of a child's neck becoming entangled in the cord loop, which may lead to strangulation. For reducing occurrence of such accidents, there are pull cord fixers available on the market. These devices secure the free end of the cord loop to a wall or window frame, reducing the likelihood of accidents.

However, the effectiveness of a pull cord fixer depends on proper installation. If mount incorrectly, such as in a position that fails to maintain sufficient tension in the cord loop, the pull cord fixer may not prevent the hazards mentioned above. Additionally, even if initially installed correctly, the cord loop may stretch over time due to material properties, resulting in slack. Since the loosening cord loop can produce a free loop, it may cause the accidents mentioned above.

### SUMMARY OF THE DISCLOSURE

In light of the above-mentioned problems, the present disclosure provides a tension fixing device used in a window covering. The window covering comprises a suspending member, a control mechanism connected with one end of the suspending member, a covering material extending downward from the suspending member, and an operating member having an annular shape. The operating member has a first section and a second section that are positioned opposite to each other. The first section passes through the control mechanism of the window covering, and the second section passes through the tension fixing device of the present disclosure, so that the operating member is tensioned. By pulling the operating member in such a state, the covering material can be controlled to be extended or retracted. The tension fixing device of the present disclosure comprises a housing having an accommodating space therein. A pushed member is arranged in the accommodating space, and the pushed member can be operated to move with respect to the housing. The pushed member comprises a first side plate, a bottom plate, a pivot pin and a positioning post. The bottom plate is perpendicularly connected with an end of the first side plate. The pivot pin is arranged on a surface of the first side plate and neighbors to another end of the first side plate other than that is connected with the bottom plate. The pivot pin has an axial direction parallel to the bottom plate. The positioning post is arranged on the first side plate and protrudes towards the housing. While the pushed member moves with respect to the housing, the positioning post moves between a first position and a second position on the housing correspondingly.

A wheel body is sleeved on the pivot pin, and the wheel body can rotate with respect to the pivot pin. A locking member is arranged between the wheel body and the bottom plate and cannot move with respect to the housing. The locking member has a locking portion corresponding to the wheel surface of the wheel body, and the second section of the operating member passes through the space between the wheel surface of the wheel body and the locking portion. The second section of the operating member operatively goes around the wheel surface of the wheel body. A biasing member has an end abutting against the bottom plate of the pushed member, and the other end abutting against the opposite side of the locking member with respect to the wheel body. The biasing member provides a pushing force tending to push the pushed member and the locking member away from each other, so that the bottom plate of the pushed member always maintains a tendency to move away from the locking member.

When the operating member is tensioned, causing the operating member to drive the pushed member to move such that the positioning post is located at the first position and the wheel surface of the wheel body is displaced to a distance from the locking portion of the locking member greater than a diameter of the operating member, the locking portion and the second section of the operating member are not in contact and the operating member can move with respect to the locking member.

When the operating member is slack, causing the biasing member to push the pushed member to move such that the positioning post is located at the second position and the wheel surface of the wheel body is displaced to the distance from the locking portion of the locking member smaller than the diameter of the operating member, the positioning post cooperates with the housing to restrict the pushed member from moving with respect to the housing, and the locking portion interferes with the second section of the operating member. As so, the operating member is restricted from moving.

Preferably, the housing comprises a first shell and a second shell that are opposite to and connected with each other, and the above-mentioned accommodation space is enclosed between the first shell and the second shell. The first shell is provided with a rail and a through hole thereon, in which the through hole penetrates the first shell to connect the accommodation space and the exterior of the housing, and the rail is concavely formed on a surface of the first shell that faces the accommodation space. The rail extends along the direction of the pushing force of the biasing member. While the pushed member moves, the positioning post slides within the rail.

Preferably, the first side plate of the pushed member is provided with a spring piece and the above-mentioned positioning post. one end of the spring piece is connected with the first side plate, while the other end of the spring piece is a free end where the positioning post is disposed. Moreover, the positioning post protrudes towards the first shell of the housing, and the spring piece can operatively deflect with respect to the first side plate to drive the positioning post to move. While the positioning post moves in the rail, the spring piece is confined by the first shell, being pressed to deflect towards the interior of the pushed member. After the positioning post moves to the through hole, an elastic restoring force of the spring piece drives the positioning post to move towards the through hole, so that the positioning post is embedded into the through hole.

In one embodiment, the spring piece and the first side plate are integrally formed into one piece. The spring piece is made by cutting part of the first side plate, in which a root portion of that cut from the first side plate remains connected with the first side plate, and a separation portion of that cut from the first side plate forms a main body of the spring piece. The main body of the spring piece can swing with respect to the first side plate when being subjected to force.

In one embodiment, the end of the rail positioned away from the through hole is defined as the first position on the housing, and the through hole is defined as the second position on the housing. The positioning post moves between the first position and the second position as the pushed member moves.

Preferably, while the positioning post moves in the rail along with the movement of the pushed member, the distance of the wheel surface of the wheel body from the locking portion remains greater than the diameter of the operating member.

In one embodiment, the operating member is a bead chain formed by interconnecting plural beads in series, and the wheel surface of the wheel body is a smooth surface. Furthermore, the locking portion of the locking member is formed in a concave shape. When the pushed member has moved such that the positioning post is located at the second position and the distance of the wheel surface of the wheel body from the locking member is smaller than the diameter of the bead, one of the beads in the second section of the operating member going around the wheel surface falls into the locking portion that is formed in the concave shape. Thereby, the operating member is restricted from moving with respect to the locking member.

In another embodiment, the operating member is a cord woven from yarn, and the locking portion of the locking member is provided with at least one first spike. When the pushed member has moved such that the positioning post is located at the second position and the distance of the wheel surface of the wheel body from the locking member is smaller than the diameter of the operating member, the first spike pierces the second section of the operating member going around the wheel surface. Thereby, the operating member is restricted from moving with respect to the locking member.

Preferably, the wheel surface of the wheel body is provided with plural second spikes, and the outer periphery of the wheel body is provided with plural recessed sections. Furthermore, the locking member comprises a limiting bump arranged correspondingly to the recessed sections. When the pushed member has moved such that the positioning post is located at the second position and the distance of the wheel surface of the wheel body from the locking member is smaller than the diameter of the operating member, at least one of the second spikes pierces the second section of the operating member going around the wheel surface of the wheel body. Concurrently, the limiting bump is engaged with the corresponding recessed section to limit the rotation of the wheel body. Therefore, the operating member is restricted from moving with respect to the wheel body and the locking member.

Preferably, the pushed member further has a second side plate symmetrically arranged with the first side plate such that the pushed member is roughly U-shaped. A pillar is provided on the side of the bottom plate facing the pivot pin, and provided for mounting the biasing member.

Another aspect of the present disclosure is to provide a tension fixing device that can further adjust the tension in the operating member having the annular shape, without reinstalling the tension fixing device.

In one embodiment, the tension fixing device of the present disclosure further comprises an adjusting seat fixed on a window frame or a wall of an architecture. The adjusting seat is hollow and has an interior shape corresponding to a contour of the housing. The housing is allowed to be inserted and fixed in the adjusting seat.

Preferably, an outer peripheral surface of the housing is further provided with plural first protruding teeth, which are arranged along the direction of the pushing force of the biasing member. At the same time, an interior surface of the adjusting seat is provided with a second protruding tooth, which corresponds to the plural first protruding teeth. When the housing is being inserted in the adjusting seat and thereby moves in a first direction, the plural first protruding teeth passes over the second protruding tooth sequentially. One of the plural first protruding teeth is selected to be engaged with the second protruding tooth, so that the housing is restricted from moving in a second direction that is opposite to the first direction.

Preferably, the more first protruding teeth that pass over the second protruding tooth while the housing moves in the first direction, the greater the tension in the operating member. The above-mentioned first direction is generally a direction away from the control mechanism of the window covering. The above-mentioned first protruding teeth are ratchet teeth.

Preferably, the housing further comprises a fastening portion provided for penetrating a screw, so that the housing can be fixed to the window frame or the wall of the architecture.

Preferably, the biasing member is a helical spring.

As mentioned above, the tension fixing device of the present disclosure has one or more of the following advantages:
(1) The tension fixing device has a positioning post and a through hole that cooperates with the positioning post. When the operating member is slack, the pushing force of the biasing member pushes the pushed member to move, such that the positioning post moves to the second position and is embedded in the through hole, and the distance of the wheel surface of the wheel body from the locking portion of the locking member is reduced to an extent that the locking portion interferes with the operating member, causing the operating member to be immovable with respect to the wheel body. As a result, the user cannot normally operate the window covering. For normally operating the window covering again, intervention by a human is required to push the positioning post into the interior of the housing while simultaneously moving the housing in the first direction (i.e., the direction away from the control mechanism of the window covering), followed by securing the tension fixing device back on the window frame or wall after the operating member has been tensioned again. Only after the above process is finished can the window covering be restored to the operable state for normal operation by the user. In other words, it is designed that the window covering cannot be used normally while the operating part is slack. In order to use the window covering normally, the wheel body must remain a sufficient distance from the locking portion that allows the operating member to pass through, which means that the operating member must lead the wheel body to resist the pushing force of the biasing member. Therefore, the user is forced to install the tension fixing device at a position where the operating member has a certain tension. In this way, the possible harm caused by the loose operating part will be effectively avoided.
(2) After the operating member is loose to an extent, causing the pushed member to move under the effect of the biasing member such that the positioning post is embedded in the through hole, the cooperation of the positioning post with the through hole ensures that the pushed member cannot move any further. In other words, there is no possibility that the pushing force of the biasing member could be accidentally overcome when the operating member is pulled in an arbitrary direction, causing the window covering to operate unexpectedly. This design requires human intervention and adjustment to restore the window covering to the operable state for normal operation by the user, further preventing the likelihood of accidents.
(3) The housing of the tension fixing device is further provided with plural first protruding teeth cooperating with the second protruding tooth of the adjusting seat. The adjusting seat is fixed on the window frame or wall. When the operating member becomes slightly slack due to long-term use, the user can easily restore the operating member to the tensioned state by moving the housing in the first direction, which leads to more amount of the first protruding teeth passing over the second protruding tooth. Therefore, the operating member can continue to be used safely, reducing the trouble of having to repeatedly reinstall the tension fixing device.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

The present disclosure will be understood by referring to the following detailed description of some illustrative embodiments in conjunction with the accompanying drawings, in which:

FIG. 1 is a perspective view of a first embodiment of the tension fixing device applied to a window covering according to the present disclosure;

FIG. 2 is another perspective view of the tension fixing device and the window covering in FIG. 1, in which the covering material of the window covering is in the different state;

FIG. 3 is an exploded perspective view of the tension fixing device in FIG. 1;

FIG. 4 is an exploded perspective view of the tension fixing device in FIG. 1 from another view angle;

FIG. 5 is a partial see-through perspective view of the tension fixing device in FIG. 1 cooperating with the operating member in the tensioned state;

FIG. 6 is a partial see-through perspective view of the tension fixing device in FIG. 1 cooperating with the operating member in the slack state;

FIG. 7 schematically shows the wheel body and the locking member clamping the operating member therebetween, according to the first embodiment of the present disclosure;

FIG. 8 schematically shows the positioning post being pushed out from the through hole, according to the first embodiment of the present disclosure;

FIG. 9 is a perspective view of a second embodiment of the tension fixing device applied to another window covering according to the present disclosure;

FIG. 10 is a perspective view of the tension fixing device and the window covering in FIG. 9, in which the tension fixing device is located at the different place;

FIG. 11 is a perspective view of the wheel body of the tension fixing device in FIG. 9;

FIG. 12 schematically shows a positional relationship between the wheel body and the locking member of the tension fixing device in FIG. 9, while the operating member is in the tensioned state;

FIG. 13 schematically show a positional relationship between the wheel body and the locking device of the tension fixing device in FIG. 10, while the operating member is in the slack state;

FIG. 14 is a partial see-through perspective view of the adjusting seat of the tension fixing device in FIG. 9;

FIG. 15 is a partial see-through perspective view of the tension fixing device in FIG. 10, while the operating member is slightly slack;

FIG. 16 schematically shows the tension fixing device in FIG. 15 applying tension to the operating member.

### DETAILED DESCRIPTION

In the following paragraphs and the accompanying drawings, the features and the implementations of several embodiments of the present disclosure are described in more detail along with the accompanying drawings. The features and the implementations described in the following paragraphs can be adopted solely or in combination with each other. In addition, the embodiments can be modified in various forms, as disclosed in the following paragraphs, and should not be limited to the embodiments described in the following paragraphs. Unless specified otherwise, the same reference characters refer to the same components.

The technical features provided in the present disclosure are not limited to the specific structures, uses, and applications described in the embodiments. The language used in the descriptions is illustrative and descriptive language which can be understood by the person of ordinary skill in the art. The terms regarding directions mentioned in the specification, including “front”, “rear”, “up”, “down”, “left”, “right”, “top”, “bottom”, “inside”, and “outside”, are illustrative and descriptive terms based on common usage scenarios, and manifests no intent to limit the scope of claims.

Furthermore, the definite and indefinite articles “a” and “the” and the numerical term “one” used in the specification referring to components of singular form do not exclude the concept of plural form. Equivalences known by one having ordinary skill in the art should be also included. All conjunctions used in similar situations should be interpreted in the broadest ways. The specific shapes, structural features, and technical terms described in the descriptions should also be interpreted to include equivalent structures and techniques which could achieve the same functionality.

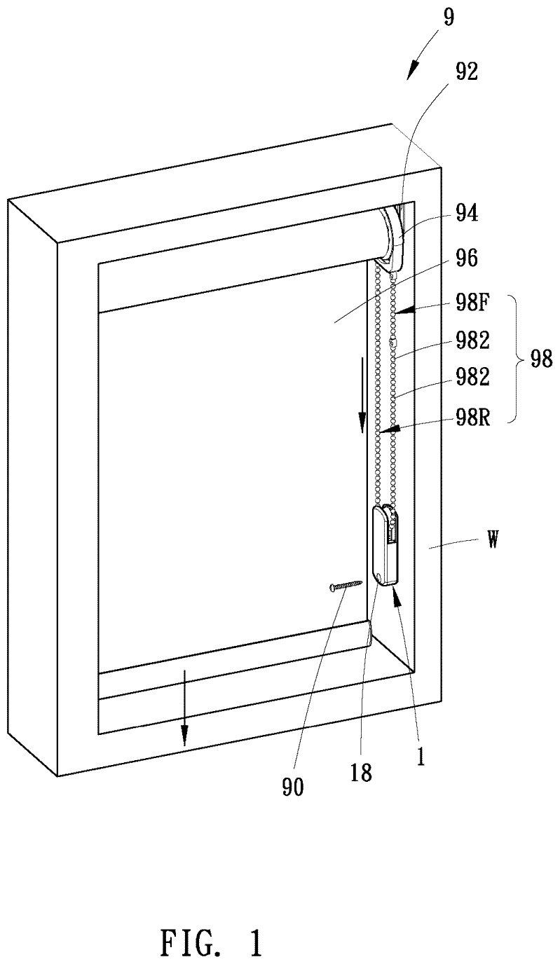

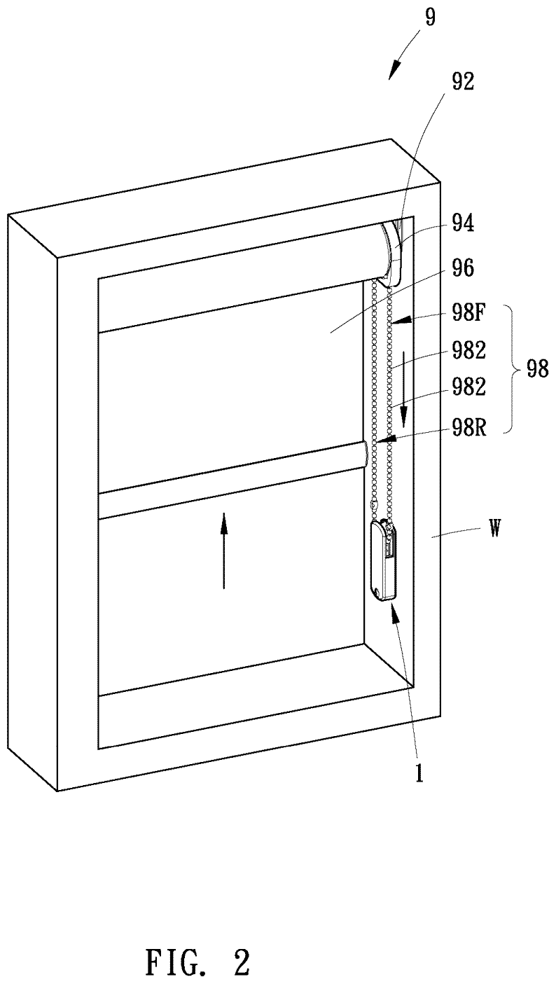

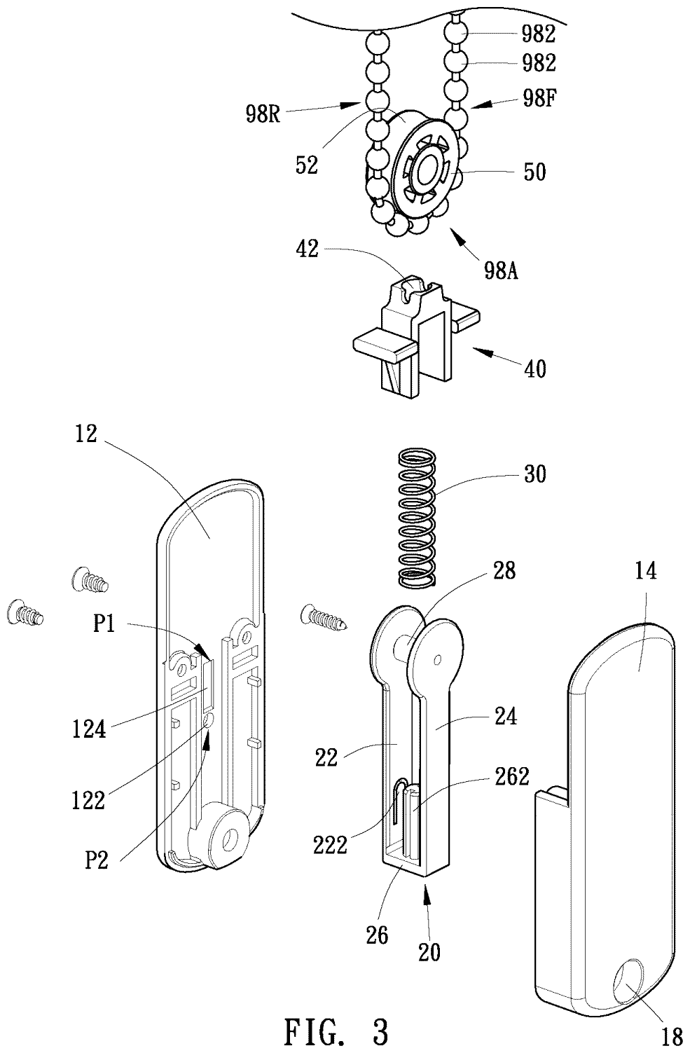

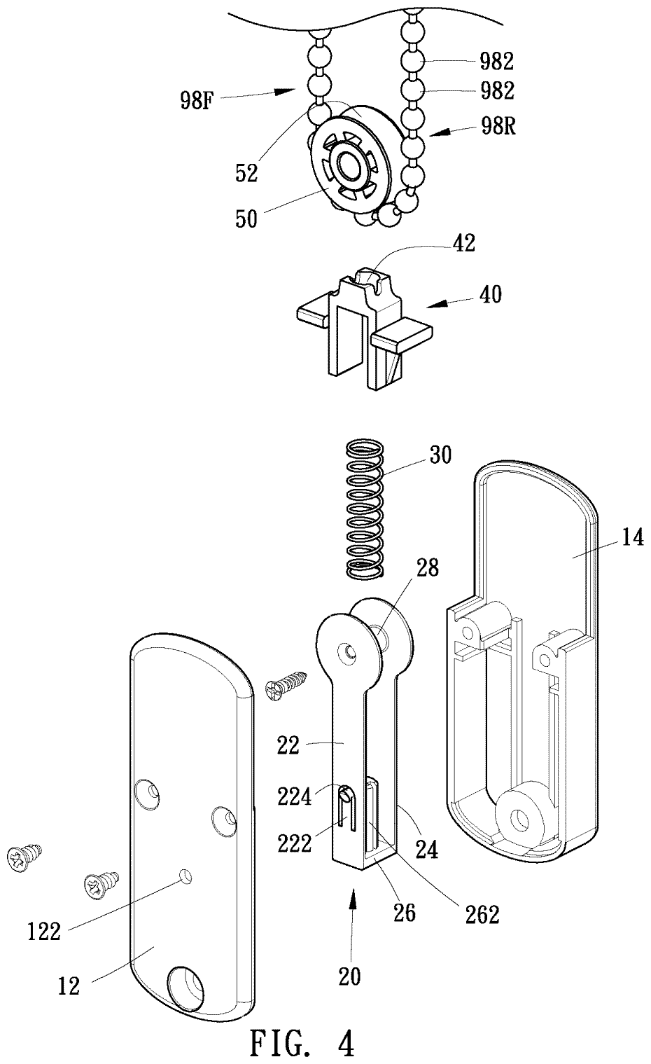

Please refer to FIGS. 1-5. In the first embodiment of the present disclosure, the tension fixing device 1 is applied to a window covering 9. The window covering 9 comprises a suspending member 92, a control mechanism 94 connected with an end of the suspending member 92, a covering material 96 extending downwardly from the suspending member 92, and an operating member 98 having an annular shape. In the present embodiment, the tension fixing device 1 is secured on a window frame W (or a wall of an architecture) by a screw 90 penetrated through a fastening portion 18 of a housing 10 of the tension fixing device 1. As a result, the tension fixing device 1 is securely fixed on the window frame W and cannot move with respect to the window frame W. In addition, in the present embodiment, the operating member 98 is a bead chain composed of plural beads 982 interconnected with each other in series. The operating member 98 has a first section (not shown) and a second section 98A opposite to each other in location. The first section (not shown) passes through the control mechanism 94 of the window covering 9 and the second section 98A passes through the tension fixing device 1, thereby applying tension to the operating member 98. In the operation of the window covering 9, the covering material 96 can be retracted upwardly by pulling down a front side chain body 98F of the operating member 98, as shown in FIG. 2. Alternatively, the covering material 96 can be extended downwardly by pulling down a rear side chain body 98R of the operating member 98, as shown in FIG. 1.

In the present embodiment, the tension fixing device 1 comprises a housing 10, a pushed member 20, a biasing member 30, a locking member 40, and a wheel body 50. The housing 10 comprises a first shell 12 and a second shell 14 opposite to and connected with each other securely, and the first shell 12 and the second shell 14 collectively enclose an accommodating space 16 therebetween. The fastening portion 18 is a pass-through hole formed on the housing 10 neighboring to a bottom end of the housing 10. The first shell 12 is provided with a through hole 122 and a rail 124 thereon. The through hole 122 penetrates through the first shell 12 to connect the accommodating space 16 and the exterior of the housing 10. The rail 124 is concavely formed on a surface on the first shell 12 that faces the accommodating space 16. The rail 124 extends in the longitudinal direction. Hereinafter, one end of the rail 124 positioned away from the through hole 122 is defined as a first position P1 on the housing 10, and the through hole 122 is defined as a second position P2 on the housing 10.

The pushed member 20 is disposed within the accommodating space 16, comprising a first side plate 22, a second side plate 24, a bottom plate 26, and a pivot pin 28. The bottom plate 26 is connected with one end of the first side plate 22 and one end of the second side plate 24, while the first side plate 22 and the second side plate 24 are configured to be generally vertical to the bottom plate 26, such that the first side plate 22 and the second side plate 24 are spaced from each other, and the first side plate 22, the second side plate 24 and the bottom plate 26 collectively form a U-shape. The pivot pin 28 is disposed between the first side plate 22 and the second side plate 24 and distanced from the bottom plate 26. Meanwhile, the pivot pin 28 has an axial direction roughly parallel to the extension of the bottom plate 26. Moreover, the pivot pin 28 cannot move with respect to the first side plate 22 and the second side plate 24. In addition, the first side plate 22 is provided with a spring piece 222. One end of the spring piece 222 is connected with the first side plate 22, and the other end of the spring piece 222 is a free end provided with a positioning post 224. The positioning post 224 protrudes towards the first shell 12 of the housing 10. That is, the positioning post 224 and the pivot pin 28 are located on the two opposite surfaces on the first side plate 22, respectively. The positioning post 224 is configured to correspond to the through hole 122 of the first shell 12 as well as the rail 124. Thereby, the positioning post 224 moves between the first position P1 and the second position P2 while the pushed member 20 moves within the accommodating space 16 with respect to the housing 10. In the present embodiment, the spring piece 222 and the first side plate 22 are integrally formed into one unitary piece. The spring piece 222 is formed by cutting part of the first side plate 22, in which a root portion of that cut from the first side plate 22 remains connected with the first side plate 22 and a separation portion of that cut from the first side plate 22 forms a main body of the spring piece 222. With this configuration, the spring piece 222 is swingable with respect to the first side plate 22 when being subjected to force.

The wheel body 50 has a wheel surface 52, which is a curved surface that is smooth and slightly concaved towards the center of the wheel body 50. Moreover, the wheel body 50 is sleeved on the pivot pin 28 in a manner that allows the wheel body 50 to rotate with respect to the pivot pin 28. The locking member 40 is disposed between the wheel body 50 and the bottom plate 26 in a manner that restricts the locking member 40 from moving with respect to the housing 10. Moreover, the locking member 40 has a locking portion 42 corresponding to the wheel surface 52 of the wheel body 50, and the second section 98A of the operating member 98 passes through the space between the wheel surface 52 and the locking portion 42. In the present embodiment, the locking portion 42 is formed as a concave recess which can receive at least part of one of the plural beads 982 of the second section 98A of the operating member 98.

Moreover, in the present embodiment, the biasing member 30 is a helical spring disposed between the locking member 40 and the bottom plate 26. The bottom plate 26 is provided with a pillar 262 for mounting one end of the biasing member 30, while the other end of the biasing member 30 abuts against a surface on the locking member 40 that faces the bottom plate 26. The biasing member 30 provides a pushing force directed outward between the pushed member 20 and the locking member 40, i.e., the pushing force tends to push the pushed member 20 and the locking member 40 away from each other. Since the locking member 40 is set immovable, the biasing member 30 keeps the pushed member 20 tending to move away from the locking member 40. Moreover, in the present embodiment, the rail 124 extends generally along the direction of the pushing force of the biasing member 30.

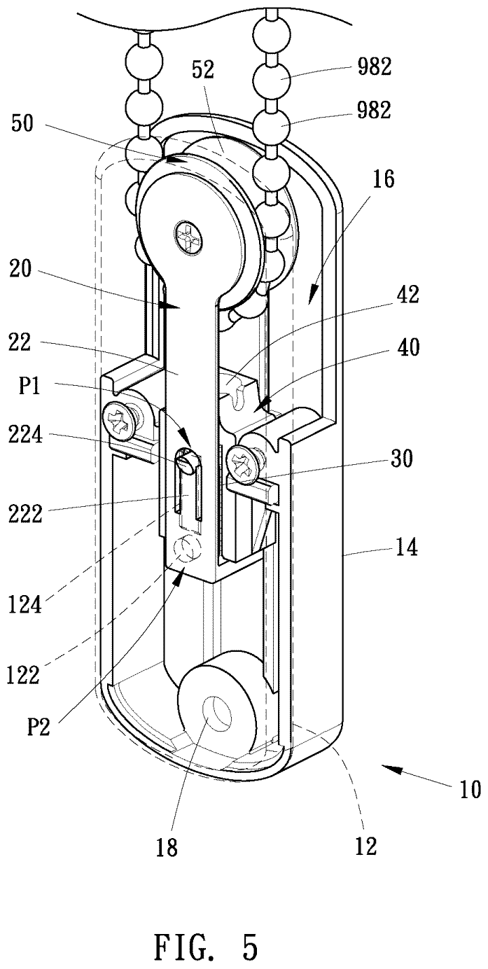

Please refer to FIG. 1 together with FIGS. 5-8. When mounting the tension fixing device 1 on the window frame W and configuring the operating member 98 to be in a tensioned state as shown in FIG. 1, referring to FIG. 5, the tension in the operating member 98 resists the pushing force of the biasing member 30 and drives the pushed member 20 to move towards the control mechanism 94 of the window covering 9 through the wheel surface 52 of the wheel body 50, as the operating member 98 goes around the wheel surface 52 of the wheel body 50. Concurrently, the positioning post 224 on the pushed member 20 is also driven to move to the first position P1 along the rail 124. At the same time, the spring piece 222 is confined by the first shell 12, being pressed towards the interior of the pushed member 20 and deflects. Meanwhile, the movement of the pushed member 20 makes the wheel surface 52 move to a distance from the locking portion 42 greater than a diameter of the bead 982. Therefore, the beads 982 are allowed to pass through the space between the wheel surface 52 and the locking portion 42 sequentially. In other words, the operating member 98 is movable with respect to the housing 10, which enables the window covering 9 to be normally operated by the user.

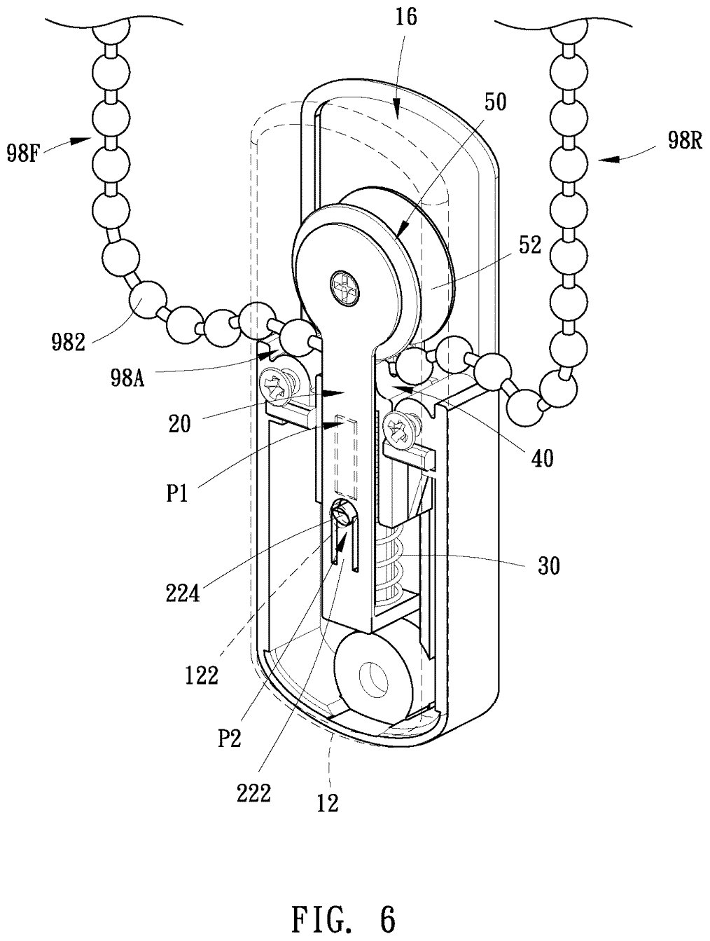

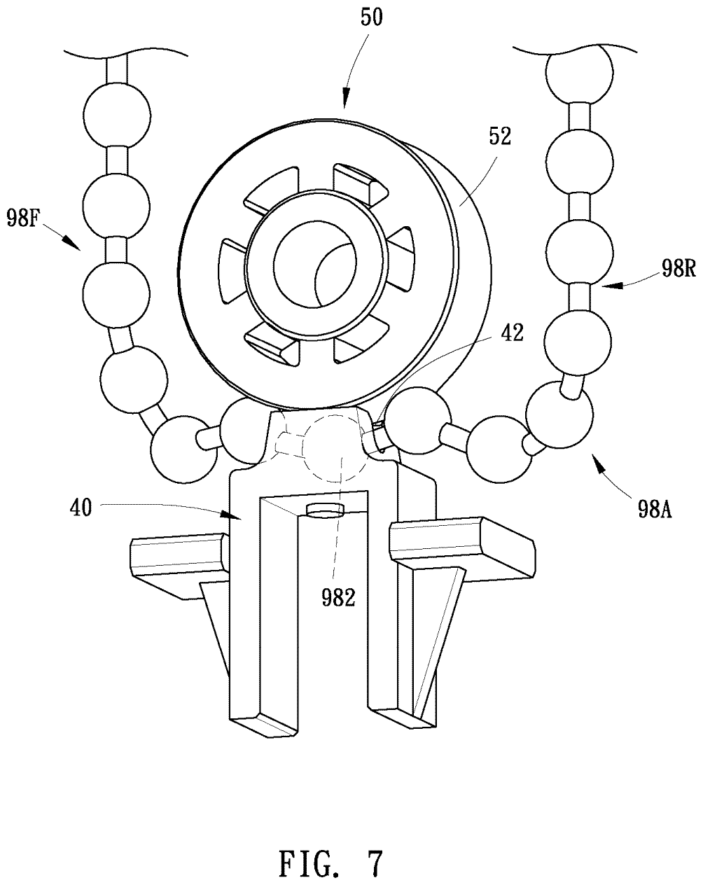

Referring to FIG. 6 and FIG. 7, when the tension fixing device 1 is removed from the window frame W (or the wall), or the tension fixing device 1 is mounted on some place where the operating member 98 presents slack, the pushing force of the biasing member 30 drives the pushed member 20 to move with respect to the locking member 40, causing the positioning post 224 to move towards the through hole 122 along the rail 124 until the positioning post 224 reaches the second position P2. Once the positioning post 224 reaches the second position P2, the positioning post 224 is embedded into the through hole 122 under an elastic restoring force provided by the spring piece 222, so that the pushed member 20 can no longer move with respect to the housing 10. At the same time, the movement of the pushed member 20 makes the wheel surface 52 move to the distance from the locking portion 42 smaller than the diameter of the bead 982, causing one of the beads 982 to be secured on the locking portion 42, as the locking portion 42 has a concave shape. As shown in FIG. 7, the bead 982 that is clamped cannot move with respect to the locking member 40. In other words, the operating member 98 cannot be moved with respect to the housing 10, which means the window covering 9 is in an inoperable state and cannot be normally operated by the user.

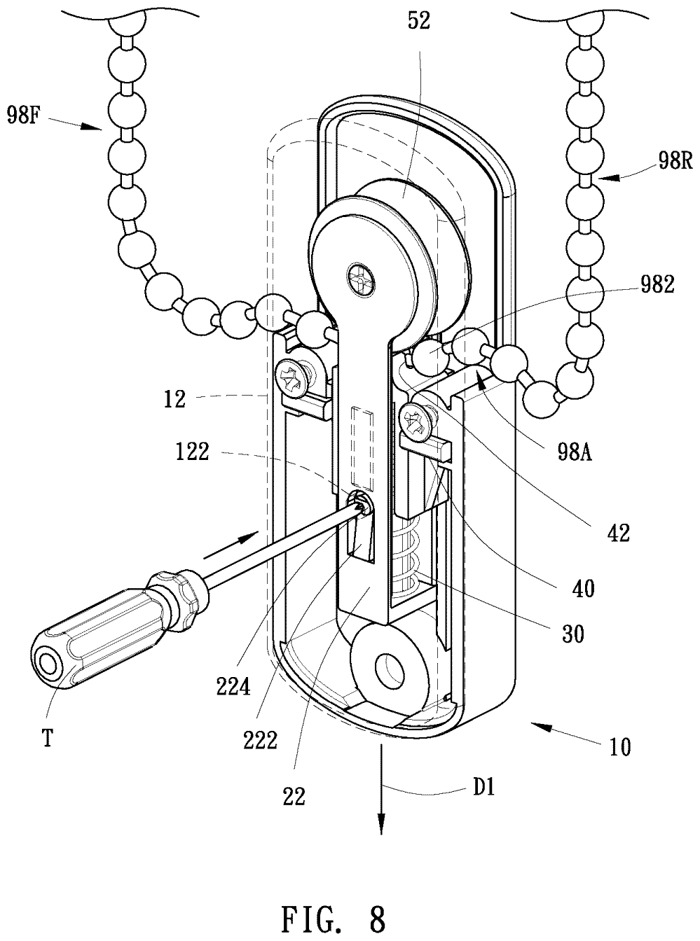

Please refer to FIG. 8 together with FIG. 6. For normally operating the window covering 9 again, firstly, the positioning post 224 is pushed towards the interior of the pushed member 20 by a tool T, e.g., a screw driver. The tool T passes through the through hoe 122 and makes the spring piece 222 deform, thereby driving the positioning post 224 to move away from the through hole 122. At the same time, the housing 10 is moved in a first direction D1 away from the control mechanism 94 of the window covering 9, thereby applying tension to the operating member 98 and turning the operating member 98 into the tensioned state. Concurrently, the operating member 98 drives the pushed member 20 to move by the wheel body 50, such that the positioning post 224 leaves the second position P2 and returns into the rail 124. In the present embodiment, it is designed that once the positioning post 224 enters the rail 124, the distance of the wheel surface 52 from the locking portion 42 becomes greater than the diameter of the bead 982 then, so that the beads 982 can pass through the space between the wheel surface 52 and the locking portion 42 sequentially. During the movement of the pushed member 20 with respect to the housing 10, the closer the positioning post 224 approaches the first position P1, the greater tension in the operating member 98. After the user moves the tension fixing device 1 to an adequate position depending on the requirement for the degree of the tension in the operating member 98 and secures the tension fixing device 1 on the window frame W, the window covering 9 can be normally operated again.

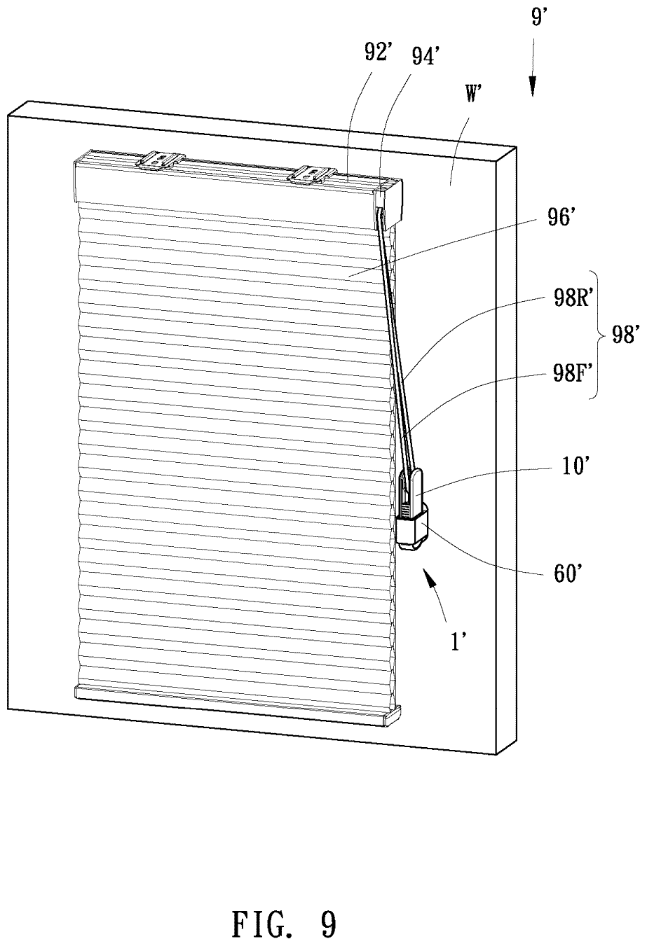

Please refer to FIGS. 9-16. In the second embodiment of the present disclosure, the tension fixing device 1′ is applied to another window covering 9′. As shown in FIG. 9, the window covering 9′ comprises a suspending member 92′ formed in a shape of a crossbeam, a control mechanism 94′ connected with an end of the suspending member 92′, a covering material 96′ extending downwardly from the suspending member 92′, and an operating member 98′ having an annular shape. In the present embodiment, the housing 10′ of the tension fixing device 1′ is confined by an adjusting seat 60′ to be engaged with the window frame W′ (or a wall of an architecture), in which the adjusting seat 60′ is secured on the window frame W′ (or the wall of the architecture) Moreover, in the present embodiment, the operating member 98′ is a cord woven from yarn. The operating member 98′ has a first section (not shown) and a second section 98A opposite to each other in location. The first section (not shown) passes through the control mechanism 94′ of the window covering 9′ and the second section 98A′ passes through the tension fixing device 1′ such that the operating member 98′ is tensioned. In the operation of the window covering 9′, the covering material 96′ can be retracted upwardly or extended downwardly, by pulling down a front side cord body 98F′ or a rear side cord body 98R′ of the operating member 98′.

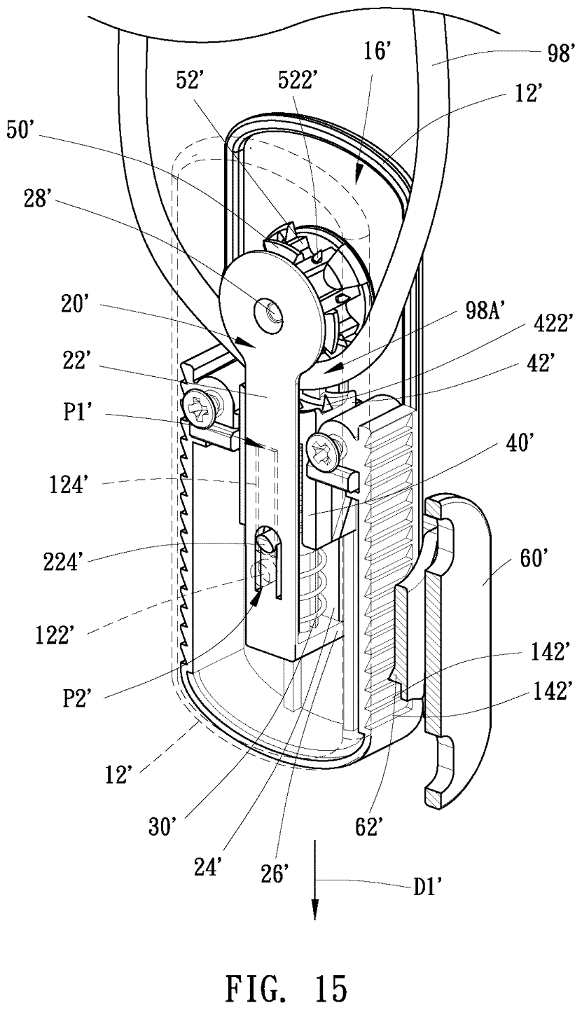

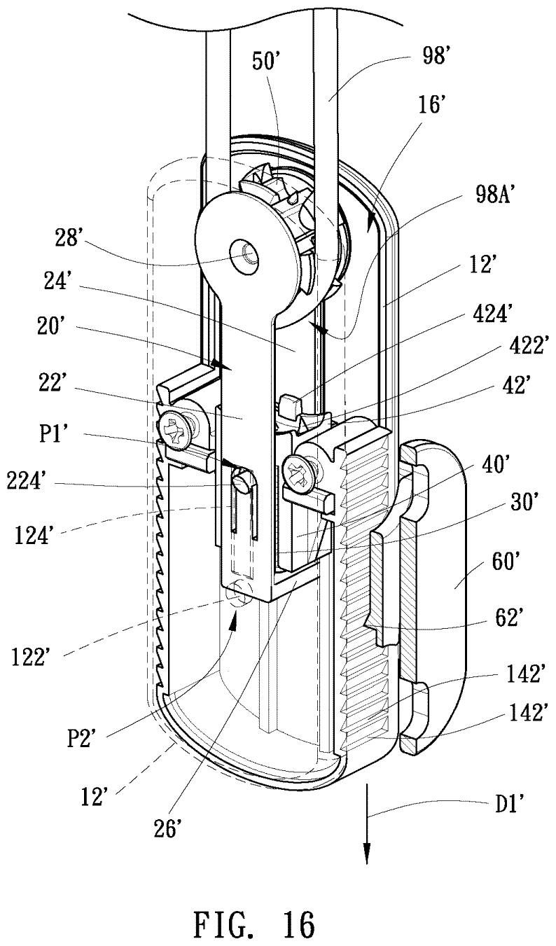

Please refer to FIG. 15 and FIG. 16. The tension fixing device 1′ of the present embodiment comprises a housing 10′, a pushed member 20′, a biasing member 30′, a locking member 40′, a wheel body 50′, and the adjusting seat 60′. The housing 10′ comprises a first shell 12′ and a second shell 14′ opposite to and connected with each other securely, and the first shell 12′ and the second shell 14′ collectively enclose an accommodating space 16′ therebetween. The first shell 12′ is provided with a through hole 122′ and a rail 124′ thereon. The through hole 122′ penetrates through the first shell 12′ to connect the accommodating space 16′ and the exterior of the housing 10′. The rail 124′ is concavely formed on a surface of the first shell 12′ that faces the accommodating space 16′. The rail 124′ extends in the longitudinal direction. Hereinafter, one end of the rail 124′ positioned away from the through hole 122′ is defined as a first position P1′ on the housing 10′, and the through hole 122′ is defined as a second position P2′ on the housing 10′.

The pushed member 20′ is disposed within the accommodating space 16′, comprising a first side plate 22′, a second side plate 24′, a bottom plate 26′, and a pivot pin 28′. The first side plate 22′ and the second side plate 24′ are configured as extending in the longitudinal direction. The bottom plate 26′ is configured as extending in the horizontal direction, and connected with one end of the first side plate 22′ and one end of the second side plate 24′, whereby the first side plate 22′ and the second side plate 24′ are spaced from each other, and the first side plate 22′, the second side plate 24′ and the bottom plate 26′ collectively form a U-shape. The pivot pin 28′ is disposed between the first side plate 22′ and the second side plate 24′ and distanced from the bottom plate 26′. The pivot pin 28′ has an axal direction generally parallel to the extension of the bottom plate 26′. Moreover, the pivot pin 28′ is set to be immovable with respect to the first side plate 22′ and the second side plate 24′. The first side plate 22′ is provided with a spring piece 222′. One end of the spring piece 222′ is connected with the first side plate 22′, and the other end of the spring piece 222′ is a free end provided with a positioning post 224′. The positioning post 224′ protrudes towards the first shell 12′ of the housing 10′. That is, the positioning post 224′ and the pivot pin 28′ are located on the two opposite surfaces on the first side plate 22′, respectively. The positioning post 224′ is configured to correspond to the through hole 122′ of the first shell 12′ as well as the rail 124′. Therefore, while the pushed member 20′ is moved within the accommodating space 16′ with respect to the housing 10′, the positioning post 224′ moves between the first position P1′ and the second position P2′.

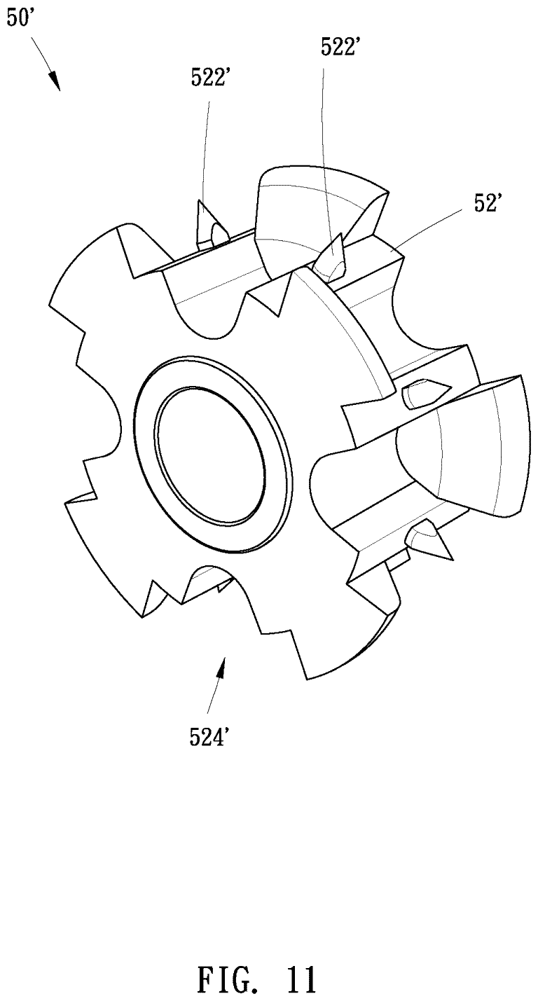

Referring to FIG. 11 and FIG. 15, the wheel body 50′ has a wheel surface 52′ slightly concaved towards the center of the wheel body 50′. The wheel surface 52′ is distributed with plural second spikes 522′ thereon. The outer periphery of the wheel body 50′ is formed with plural concave sections 524′. The wheel body 50′ is sleeved on the pivot pin 28′ in a manner that allows the wheel body 50′ to rotate with respect to the pivot pin 28′.

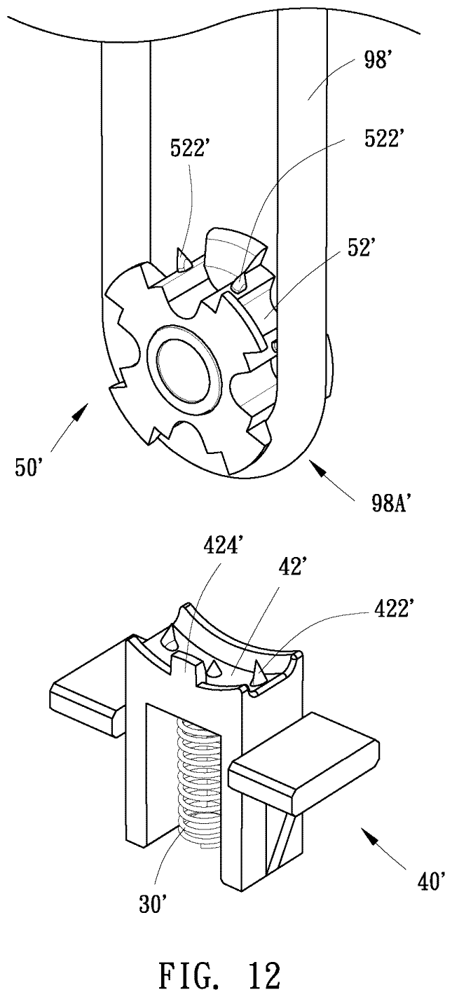

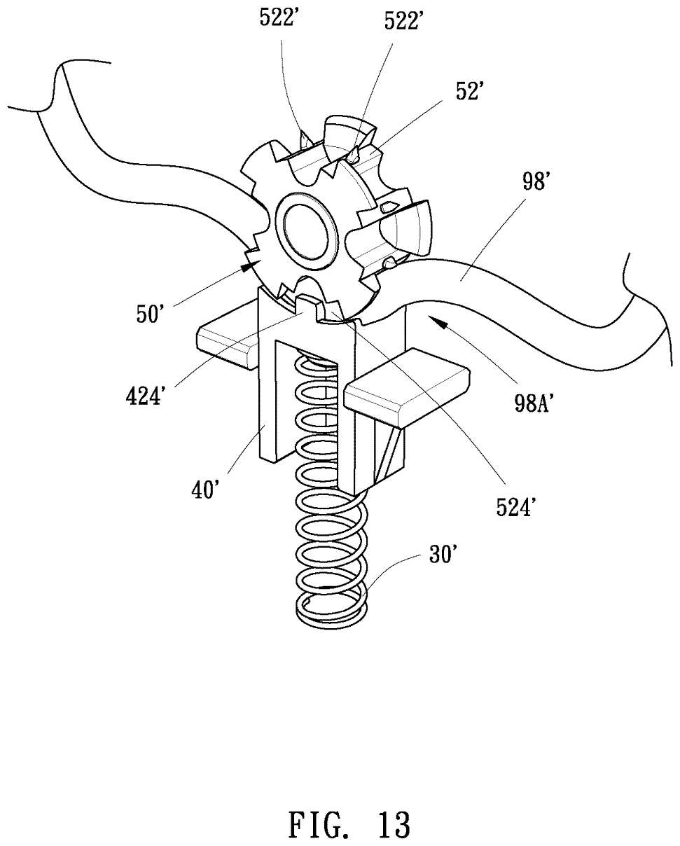

Referring to FIG. 12 and FIG. 13, the locking member 40′ has a locking portion 42′. The locking portion 42′ has plural first spikes 422′ and a limiting bump 424′. The first spikes 422′ correspond to the wheel surface 52′ of the wheel body 50′, and the limiting bump 424′ corresponds to the concave sections 524′ of the wheel body 50′. Referring to FIG. 15 and FIG. 16, the locking member 40′ is disposed between the wheel body 50′ and the bottom plate 26′ in a manner that restricts the locking member 40′ from moving with respect to the housing 10′, and the second section 98A′ of the operating member 98′ passes through the space between the wheel surface 52′ and the locking portion 42′.

Moreover, in the present embodiment, as shown in FIGS. 12-16, the biasing member 30′ is a helical spring disposed between the locking member 40′ and the bottom plate 26′. The two ends of the biasing member 30′ respectively abut against the two surfaces opposite to each other, each located on the locking member 40′ and the bottom plate 26′, respectively. The biasing member 30′ provides a pushing force directed outward between the pushed member 20′ and the locking member 40′, i.e., the pushing force tends to push the pushed member 20′ and the locking member 40′ away from each other. Since the locking member 40′ is set to be immovable, the biasing member 30′ keeps the pushed member 20′ tending to move away from the locking member 40′. Furthermore, in the present embodiment, the rail 124′ extends generally along the direction of the pushing force of the biasing member 30′.

Please refer to FIGS. 9, 12, 15 and 16. When mounting the tension fixing device 1′ onto the window frame W′ and configuring the operating member 98′ to be in a tensioned state as shown in FIG. 9, the tension in the operating member 98′ resists the pushing force of the biasing member 30′, so that the operating member 98′ drives the pushed member 20′ to move towards the control mechanism 94′ of the window covering 9′ by the wheel surface 52′ of the wheel body 50′, as the operating member 98′ goes around the operating member 98′. Concurrently, the positioning post 224′ on the pushed member 20′ is also driven to move along the rail 124′ until reaching the first position P1′ (see FIG. 16). During the movement of the positioning post 224′ along the rail 124′ until reaching the first position P1′, the distance between the wheel surface 52′ and the locking portion 42′ remains greater than a diameter of a cord body 982′, such that the second section 98A′ of the operating member 98′ is allowed to pass through the space between the wheel surface 52′ and the locking portion 42′. In other words, the operating member 98′ is movable with respect to the housing 10′, which enables the window covering 9′ to be operable that the window covering 9′ can be normally operated by the user.

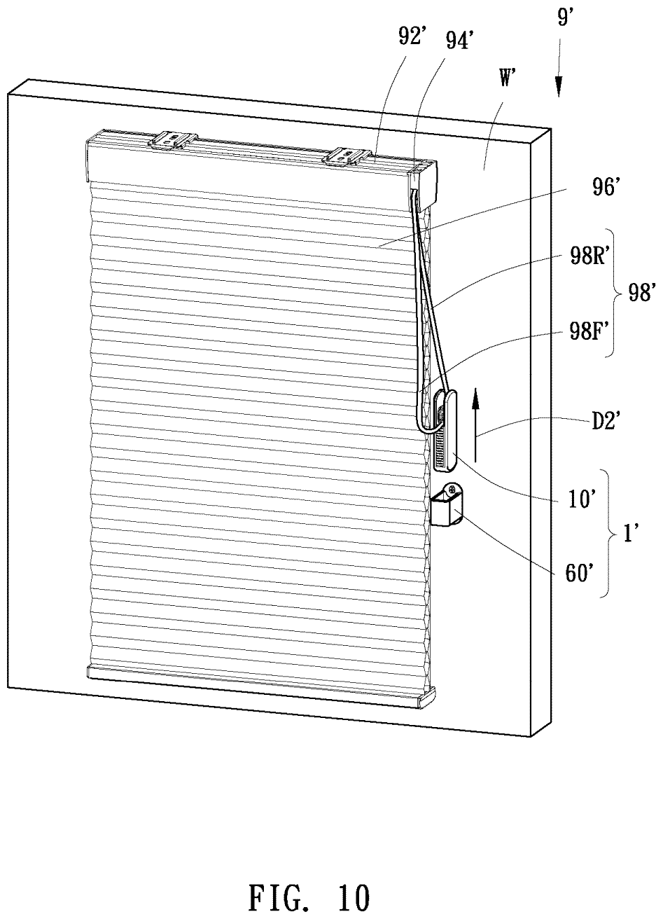

Please refer to FIG. 10 and FIG. 13. When the operating member 98′ is in a slack state, similar to the previous embodiment, the pushing force of the biasing member 30′ drives the pushed member 20′ to move with respect to the locking member 40′, causing the positioning post 224′ to move to the through hole 122′ and to be embedded in the through hole 122′, whereby the pushed member 20′ (not shown in FIG. 10 and FIG. 13) can no longer move with respect to the housing 10′. At the same time, the movement of the pushed member 20′ makes the wheel surface 52′ move such that the distance of the wheel surface 52′ from the locking portion 42′ becomes smaller than the diameter of the operating member 98′. As a result, referring to FIG. 13, the second section 98A′ of the operating member 98′ is clamped between the locking portion 42′ and the wheel surface 52′, while the first spike 422′ of the locking portion 42′ and the second spikes 522′ of the wheel surface 52′ pierce the second section 98A′ of the operating member 98′, respectively. Moreover, the limiting bump 424′ is engaged with the corresponding one of the concave sections 524′ for limiting the rotation of the wheel body 50′. Therefore, the operating member 98′ can no longer move with respect to the housing 10′, and the window covering 9′ becomes inoperable that cannot be normally operated by the user. For restoring the window covering 9′ to the operable state that can be normally operated by the user, an external force is required to make the positioning post 224′ move away from the through hole 122′ and return into the rail 124′, as shown in FIG. 8, while FIG. 8 depicts the previous embodiment. The related principles have been described in the previous context and will not be redundantly described here again.

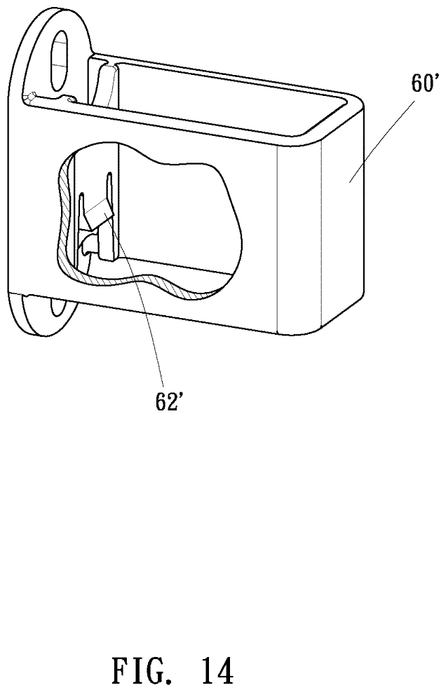

Please refer to FIG. 10 together with FIGS. 14-16. In some cases, applying tension to the operating member 98′ to change the operating member 98′ from the slack state to the tensioned state can be implemented without any tool, if the operating member 98′ is not slack to an extent that the positioning post 224′ has moved to the second position P2′ and fallen into the second through hole 122′. Such a situation might occur because the tension fixing device 1′ were mounted incorrectly, or the housing 10′ had been moved in a second direction D2′ towards the control mechanism 94′, as shown in FIG. 10. Alternatively, the tension fixing device 1′ might had been mounted correctly at the beginning, but became slack after long-term use because of continuous extension.

Please refer to FIGS. 10, 14, 15 and 16. The outer peripheral surface of the housing 10′ is provided with plural first protruding teeth 142′. The first protruding teeth 142′ are aligned parallel to each other, and arranged along a direction parallel to the direction of the pushing force of the biasing member 30′. Referring to FIG. 14, in the present embodiment, the adjusting seat 60′ has a hollow structure. An inner shape of the hollow structure of the adjusting seat 60′ roughly corresponds to the contour of the housing 10′, so that the housing 10′ can be inserted and fixed therein. An interior surface of the adjusting seat 60′ is provided with a second protruding tooth 62′ corresponding to the first protruding teeth 142′ on the outer peripheral surface of the housing 10′. In the present embodiment, the first protruding teeth 142′ are ratchet teeth, so that the housing 10′ is limited to move unidirectionally in the first direction D1′ and not allowed to move in the second direction D2′ opposite to the first direction D1′. That is, the housing 10′ is restricted from moving in the direction towards the control mechanism 94′. Thereby, after the housing 10′ is inserted and fixed in the adjusting seat 60′, the adjusting seat 60′ holds the housing 10′ on the window frame W′ and confines the movement of the housing 10′.

As shown in FIG. 15, the operating member 98′ is slightly slack. At this moment, the adjusting seat 60′ is located at a relatively lower position with respect to the housing 10′, in which an amount of the first protruding teeth 142′ which had passed over the second protruding tooth 62′ by the movement of the housing 10′ in the first direction D1′ is merely three. On the purpose of increasing the tension in the operating member 98′, the housing 10′ can be further moved in the first direction D1′ until the positioning post 224′ of the pushed member 20′ is located at the first position P1′. During the movement of the housing 10′ in the first direction D1′, the more amount of the first protruding teeth 142′ passing over the second protruding tooth 62′, the farther away the wheel body 50′ is located from the control mechanism 94′, resulting in the more degree of the stretchiness and the greater tension in the operating member 98′.

With the configuration of the tension fixing device 1, 1′ of the present disclosure, when the operating member 98, 98′ in the form of a bead chain or a cord is excessively loose and becomes slack, the pushing force of the biasing member 30, 30′ makes the positioning post 224, 224′ embedded into the through hole 122, 122′, and concurrently reduces the distance of the wheel surface 52, 52′ of the wheel body 50, 50′ from the locking portion 42, 42′ of the locking member 40, 40′. Thereby, the locking portion 42, 42′ interferes with the operating member 98, 98′, causing the operating member 98, 98′ to be immovable with respect to the wheel body 50, 50′. Only after manually resetting the tension fixing device 1, 1′ can the window covering 9, 9′ be normally operated by the user again. In other words, the user is forced to set the tension fixing device 1, 1′ at a position where the tension in the operating member 98, 98′ remains in a certain level. Thereby, the danger may be caused by the slack of the operating member 98, 98′ is avoided. In addition, by the cooperation of the positioning post 224, 224′ as well as the through hole 122, 122′, when the operating member 98, 98′ is loose to the extent that the positioning post 224, 224′ is embedded into the through hole 122, 122′, the pushed member 20, 20′ can no longer move. Thereby, an unexpected situation is prevented, in which the operating member 98, 98′ accidentally overcomes the pushing force of the biasing member 30, 30′ when being pulled in an arbitrary direction, resulting in the window covering 9, 9′ being normally operated. Therefore, the accidents are further prevented from happening.

Furthermore, since the tension fixing device 1′ of the present disclosure has the first protruding teeth 142′ and the second protruding tooth 62′ cooperating with each other, when the operating member 98′ is merely loose to a small degree, the tension in the operating member 98′ can be easily adjusted without resetting the tension fixing device 1′. Therefore, the window covering 9′ can continue to be used safely, reducing the trouble of having to repeatedly reinstall the tension fixing device 1′.

The embodiments described above are only some exemplary embodiments of the present disclosure. All equivalent structures which employ the concepts disclosed in this specification and the appended claims should fall within the scope of the present disclosure.

What is claimed is:

1. A tension fixing device used in a window covering, wherein the window covering has a suspending member, a control mechanism connected with an end of the suspending member, a covering material extending downwardly from the suspending member and an operating member, wherein the operating member has an annular shape, and has a first section and a second section opposite to each other, wherein the first section passes through the control mechanism and the second section passes through the tension fixing device for tensioning the operating member so that the operating member is configured to be pulled to control the extension or retraction of the covering material, the tension fixing device comprising:
a housing, having an accommodating space therein;
a pushed member, disposed within the accommodating space and operatively movable with respect to the housing, comprising:
a first side plate;
a bottom plate, connected with an end of the first side plate and disposed substantially perpendicularly to the first side plate;
a pivot pin, disposed on a surface on the first side plate and neighboring to the other end of the first side plate, the pivot pin having an axial direction substantially parallel to the bottom plate; and
a positioning post, disposed on the first side plate and extending towards the housing, wherein while the pushed member moves with respect to the housing, the positioning post correspondingly moves between a first position and a second position on the housing;
a wheel body, sleeved on the pivot pin and rotatable with respect to the pivot pin;
a locking member, disposed between the wheel body and the bottom plate and being immovable with respect to the housing, the locking member comprising a locking portion corresponding to a wheel surface of the wheel body, and the second section of the operating member passes through space between the wheel surface of the wheel body and the locking portion, wherein the second section of the operating member operatively goes around the wheel surface of the wheel body; and
a biasing member, having an end abutting against the bottom plate of the pushed member and another end abutting against an opposite side of the locking member with respect to the wheel body, the biasing member providing a pushing force directed outward between the pushed member and the locking member, which makes the bottom plate of the pushed member constantly tend to move away from the locking member;
wherein when the operating member is tensioned such that the operating member has driven the pushed member to move until the positioning post is located at the first position by which the wheel surface of the wheel body has moved to a distance from the locking portion of the locking member greater than a diameter of the operating member, the locking portion and the second section of the operating member are not in contact and the operating member is movable with respect to the locking member;
when the operating member is slack such that the biasing member has pushed the pushed member to move until the positioning post is located at the second position by which the wheel surface of the wheel body has been driven to move to the distance from the locking portion of the locking member smaller than the diameter of the operating member, the positioning post cooperates with the housing to restrict the pushed member from moving with respect to the housing, and the locking portion interferes with the second section of the operating member for restricting the operating member from moving.

2. The tension fixing device of claim 1, wherein the housing comprises a first shell and a second shell opposing to and connected with other, and the first shell and the second shell define an accommodating space therebetween; the first shell is provided with a rail and a through hole thereon, wherein the through hole penetrates through the first shell to connect the accommodating space and the exterior of the housing, and the rail is concavely formed on a surface of the first shell facing the accommodating space; the rail extends along a direction of the pushing force of the biasing member, so that the positioning post slides within the rail while the pushed member moves.

3. The tension fixing device of claim 2, wherein the pushed member further comprises a spring piece, and the spring piece and the positioning post are disposed on the first side plate of the pushed member; the spring piece has an end connected with the first side plate and another end being a free end where the positioning post is disposed, while the positioning post protrudes towards the first shell of the housing; the spring piece is operatively swingable with respect to the first side plate for driving the positioning post to move; when the positioning post moves within the rail, the spring piece is confined by the first shell and thereby pressed to swing towards the interior of the pushed member; when the positioning post has moved to the through hole, an elastic restoring force of the spring piece drives the positioning post to move towards the through hole, thereby making the positioning post embedded into the through hole.

4. The tension fixing device of claim 3, wherein the spring piece and the first side plate are integrally formed into one piece as the spring piece is defined by cutting part of the first side plate, in which a root portion of that cut from the first side plate remains connected with the first side plate, and a separation portion of that cut from the first side plate forms a main body of the spring piece; the main body of the spring piece is swingable with respect to the first side plate when being subjected to force.

5. The tension fixing device of claim 3, wherein an end of the rail positioned away from the through hole is defined as the first position, and the through hole is defined as the second position; the positioning post moves between the first position and the second position as the pushed member moves.

6. The tension fixing device of claim 3, wherein while the positioning post moves in the rail as the pushed member moves, the distance of the wheel body of the wheel body from the locking member is greater than the diameter of the operating member.

7. The tension fixing device of claim 1, wherein the operating member is a bead chain comprising plural beads interconnected with each other; the wheel surface of the wheel body is a smooth surface, and the locking portion of the locking member is formed in a concave shape; when the pushed member has moved such that the positioning post is located at the second position and the distance of the wheel surface of the wheel body from the locking member is smaller than a diameter of each of the plural beads, one of the beads of the second section of the operating member that goes around the wheel surface of the wheel body falls in the locking portion that is formed in the concave shape, thereby restricting the operating member from moving with respect to the locking member.

8. The tension fixing device of claim 1, wherein the operating member is a cord woven from yarn, and the locking portion of the locking member has at least one first spike; when the pushed member has moved such that the positioning post is located at the second position and the distance of the wheel surface of the wheel body from the locking member is smaller than the diameter of the operating member, the at least one first spike pierces the second section of the operating member that goes around the wheel surface of the wheel body, thereby restricting the operating member from moving with respect to the locking member.

9. The tension fixing device of claim 8, wherein the wheel surface of the wheel body is provided with plural second spikes, and an outer periphery of the wheel body has plural recessed sections; the locking member comprises a limiting bump corresponding to the recessed sections; when the pushed member has moved such that the positioning post is located at the second position and the distance of the wheel surface of the wheel body from the locking member is smaller than the diameter of the operating member, at least one of the plural second spikes pierces the second section of the operating member that goes around the wheel surface of the wheel body, and the limiting bump is engaged with a corresponding one of the recessed sections for limiting the wheel body from rotating, thereby restricting the operating member from moving with respect to the wheel body and the locking member.

10. The tension fixing device of claim 1, wherein the pushed member further comprises a second side plate configured to be symmetrical to the first side plate such that the pushed member is substantially formed in a U-shape; a side of the bottom plate facing the pivot pin is provided with a pillar for mounting the biasing member.

11. The tension fixing device of claim 1, further comprising an adjusting seat fixing on a window frame or a wall, wherein the adjusting seat is hollow and has an interior shape corresponding to a contour of the housing, so that the housing is allowed to be inserted and fixed in the adjusting seat.

12. The tension fixing device of claim 11, wherein an outer peripheral surface of the housing further has plural first protruding teeth arranged along a direction of the pushing force of the biasing member, and an interior surface of the adjusting seat is provided with a second protruding tooth corresponding to the plural first protruding teeth; when the housing is being inserted in the adjusting seat in a first direction to be fixed in the adjusting seat, the plural first protruding teeth passes over the second protruding tooth sequentially, after which one of the plural first protruding teeth is selectively engaged with the second protruding tooth, thereby restricting the housing from moving in a second direction that is opposite to the first direction.

13. The tension fixing device of claim 12, wherein as an amount of the first protruding teeth passing over the second protruding tooth increases, the tension in the operating member becomes greater.

14. The tension fixing device of claim 12, wherein the first direction is substantially a direction away from the control mechanism of the window covering.

15. The tension fixing device of claim 12, wherein the plural first protruding teeth are ratchet teeth.

16. The tension fixing device of claim 1, wherein the housing further comprises a fastening portion provided to be threaded through by a screw for fixing the housing on a window frame or a wall.

17. The tension fixing device of claim 1, wherein the biasing member is a helical spring.
